(19) United States
(12) Patent Application Publication
(10) Pub. No.: US 2025/0392495 A1
(43) Pub. Date: Dec. 25, 2025

(54) NETWORK-TO-NETWORK GATEWAY, VEHICLE WITH A GATEWAY AND METHODS FOR DEVELOPING A GATEWAY AND TESTING USING A GATEWAY

(71) Applicant: FEV Group GmbH, Aachen (DE)

(72) Inventor: Thomas Deweerdt, Auburn Hills, MI (US)

(73) Assignee: FEV Group GmbH, Aachen (DE)

(21) Appl. No.: 18/753,501

(22) Filed: Jun. 25, 2024

(51) Int. Cl. H04L 12/66; G06F 3/04842; G06F 3/0488; G06F 8/65; G06F 11/36; H04L 65/102

(52) U.S. Cl. CPC H04L 12/66; G06F 3/04842; G06F 3/0488; G06F 8/65; G06F 11/3696; H04L 65/102

(57) ABSTRACT

The present disclosure relates to a network-to-network gateway for vehicles, including a motherboard, a data processing unit and connectors and/or interfaces for interaction by digital data and a touch screen. Further aspects of the present disclosure are a vehicle with a gateway according to the present disclosure and methods for developing and performing tests with a gateway according to the present disclosure.

### FIELD OF THE INVENTION

The present disclosure relates generally to the field of network-to-network gateways for vehicles, and more particularly to a modular, user-friendly network-to-network gateway for use in vehicles, to a vehicle having a gateway, to a method of developing a gateway, and to a method of performing tests using a gateway according to the present disclosure.

### BACKGROUND

Network-to-network gateways for use in vehicles, vehicles having network-to-network gateways, and methods of developing and performing tests using a network-to-network gateway are known in the art.

### SUMMARY

Various embodiments provide a gateway, a vehicle having a gateway, and methods described by the subject matter of the independent claims. Advantageous embodiments are described in the dependent claims. Embodiments of the present disclosure may be freely combined where they are not mutually exclusive.

The network-to-network gateway according to a first aspect of the present disclosure includes a motherboard and a data processing unit. The gateway further includes a digital data interface and/or a connector for detachably connecting a digital data interface to the gateway, and a touch screen and/or a connector for detachably connecting a touch screen to the gateway.

The use of connectors that allow detachable connection can help to provide an improved modular gateway. This can help improve the ability of the gateway to adapt to changing or yet unknown future requirements, for example by adding new modules using connectors or replacing existing modules.

In addition, the use of a touch screen that allows operation directly on the device can help increase security by preventing data transmission to other devices, which can be used as an approach for cyber attacks.

Similarly, a touch screen directly on the gateway can help reduce the effort and complexity of operating the gateway by eliminating the need for additional devices such as a laptop, tablet, or mobile phone and by eliminating the need for additional software such as applications for a laptop, tablet, or mobile phone.

In the context of the present disclosure, a network-to-network gateway refers to a device that connects networks and transfers data between these networks. It can be used in various environments, particularly in vehicles.

In the context of the present disclosure, a vehicle is any vessel used to transport people or goods. It can be a car, a truck, a motorcycle, but also a ship, an airplane, or similar machines.

A motherboard is a central circuit board in an electronic device on which most or all of the major components are mounted. It contains the circuits that connect the various parts of the device.

A processor is an electronic device that processes data. For example, it may consist of one or more microprocessors and be responsible for running software.

A digital interface is a mechanism that allows an electronic device to exchange digital data with other electronic devices. It can take several forms, including but not limited to USB ports, Ethernet ports, Wi-Fi connections, and more.

A touch screen is an electronic input and display device that allows a user to interact with an electronic device by tapping or swiping.

A connector allows two parts of a system to be connected, such as a digital data interface or a touch screen to be detachably connected to a gateway.

In a further embodiment of the network-to-network gateway of the present disclosure, the gateway comprises a first daughter board and/or a connector for detachably connecting a first daughter board to the gateway.

This can help to provide improved flexibility to adapt to changing or yet unknown future requirements. By using a daughter board and a connector, the gateway can be modified to add new features or enhance existing features. This can also extend the life of the gateway.

A daughter board is a smaller board attached to a motherboard that performs specific functions. It may contain various components required for the specific functions of the gateway.

In a further embodiment of the network-to-network gateway according to the present disclosure, the gateway comprises a second daughter board and/or a connector for detachably connecting a second daughter board to the gateway.

This can help to increase functional safety or to achieve a safety level according to a predefined standard, such as ASIL C or ASIL D, more efficiently.

For example, a second daughter board can be used to provide redundancy to the first daughter board. This can help to ensure that the gateway continues to function even if the first daughter board fails, thereby increasing the reliability and safety of the system.

In the context of the present disclosure, functional safety refers to the reliable provision of the safety functions of a system, particularly in the event of failure or malfunction of subsystems. It includes measures to limit possible risks by avoiding systematic errors, detecting random errors and reacting to detected errors. Only the risks arising from the functions of the system (hardware, software, mechanics) are considered.

ASIL stands for Automotive Safety Integrity Level and is a risk classification scheme defined in ISO 26262-Functional Safety for Road Vehicles. It is an adaptation of the Safety Integrity Level (SIL) used in IEC 61508 for the automotive industry.

ASIL C and ASIL D are two of the four levels. ASIL D places the highest integrity requirements on the product and ASIL A the lowest.

In a further embodiment of the network-to-network gateway according to the present disclosure, the gateway includes an analog interface and/or a connector for detachably connecting an analog interface to the gateway.

This can help provide improved diagnostic and test capabilities, especially with respect to systems and components connected to the gateway. For example, feedback can be enabled with analog devices. The feedback can be used to verify that control commands have been executed. This can also help increase reliability and safety, as any errors or problems can be detected and corrected more quickly.

In addition, connecting via connectors can help provide improved connectivity when needed or desired, such as during development and testing of a gateway, vehicle, or vehicle component. After development and testing, the analog interface can be omitted during operation to reduce the complexity and effort of deploying a gateway.

Analog interface refers to an interface that carries analog signals. Analog signals are continuous signals that can represent an almost infinite number of states, as opposed to digital signals that represent a limited number of states. Analog interfaces are used, for example, to connect to devices that use analog signals, such as analog sensors or actuators.

In another embodiment of the network-to-network gateway of the present disclosure, the gateway may include several additional interfaces and modules, such as a serial bus interface, Ethernet interface, debug interface, USB interface, SD card interface, Wi-Fi interface, telematics data interface, Bluetooth interface, or an array of programmable LEDs. The gateway may also include additional connectors that allow such interfaces and modules to be detachably connected to the gateway.

This allows the gateway to be flexibly and efficiently adapted to different requirements. In addition, interfaces and modules can be easily and efficiently provisioned in a vehicle. Many different, heterogeneous components for interface provisioning may be eliminated, which increases the efficiency of provisioning and reduces its complexity. In addition, connectors can help to mount interfaces and modules only when needed, and not otherwise, reducing the complexity and effort of deploying and operating the gateway.

A serial bus interface refers to a serial interface used for communication between different devices on a network. It can take several forms, such as a Local Interconnect Network (LIN) bus interface or a Controller Area Network (CAN) bus interface.

An Ethernet interface is a network interface used for data transmission over a network. In some embodiments, the Ethernet interface is configured to be used to transfer data at a rate of 1 Gbps (gigabit per second) or more.

A debug interface is an interface used for troubleshooting and debugging a system.

A USB interface is a Universal Serial Bus interface used to connect and communicate between different devices. It can have different versions, such as, without limitation, USB 2.0, 3.0, or higher.

An SD card interface is an interface used to communicate with an SD card. It provides access to the data stored on the SD card.

A Wi-Fi interface is a wireless network interface used to communicate on a wireless network. It can support various standards, such as, without limitation, Dual Band 802.11ae.

A telematics data interface is an interface used to communicate digital data on a telematics network. It can support different standards, such as, without limitation, GNSS, 3G, 4G, 5G, 6G or higher.

A Bluetooth interface is a wireless interface used for short-range communication between different devices. It can have different versions, such as, without limitation, Bluetooth 5.0 or higher.

A programmable LED array is a group of LEDs whose behavior can be controlled by programming. They can be used to display status information, for example.

A stack-on module (SOM) is a type of module that is plugged onto a motherboard or another module. This may be done for different reasons. For example, to provide additional functionality. It may contain various components and may be designed to be particularly easy to add or remove to expand or customize the functionality of a system.

In a non-limiting example, the SOM may be a ready-to-use, dual-port Ethernet module solution configured for the real-time protocols PROFINET RT, EtherNetIP, EtherCAT, including an embedded 2-port Ethernet switch with further internal port for bus and ring network topologies to integrate with the processor or microcontroller running a protocol library supporting various types of real-time industrial Ethernet communication protocols. Further, with use of an Application Programming Interface (API), the protocol library may be easily accessed by the processor in order to exchange real-time network data with the user application via a module interface.

In a further embodiment of the network-to-network gateway according to the present disclosure, the gateway includes one or more connectors that may be configured as SOMs.

Such an arrangement may provide improved modularity and flexibility to adapt to changing requirements. By using SOMs, the gateway can be more easily modified to add new features or enhance existing features. This extends the life of the gateway. In addition, the gateway can be adapted to specific requirements by replacing modules. As such, arrangements described herein provide improvements in computer functionality and at least provide solutions to technical problems in this field by extending the life of the gateway.

In a further embodiment of the network-to-network gateway according to the present disclosure, the gateway is arranged such that, when a touch screen is connected to the gateway, it allows, via the connected touch screen, to select and control the execution of a test, for example to test the function of the gateway, a component or subsystem of the gateway, or a device or system connected to the gateway via a digital or analog interface. It also allows the input or entry and display of test data and test parameters, and/or the selection of a test data analysis and control of the execution of a test data analysis. As such, arrangements described herein provide improvements in computer functionality, improvements in user interfaces and selections, and further provides solutions to technical problems in this field by reducing effort and complexity of performing testing of the gateway, a component or subsystem of the gateway, or a device or system connected to the gateway via a digital or analog interface.

Such an arrangement reduces the effort and complexity of testing by reducing the need for additional devices such as a laptop, tablet, or mobile phone. It also can also reduce the need for additional software, such as applications for a laptop, tablet, or mobile phone. As such, arrangements described herein provide improvements in computer functionality and at least provide solutions to technical problems in this field by reducing effort and complexity of operating the gateway by eliminating the need for additional devices.

In a further embodiment of the network-to-network gateway of the present disclosure, the gateway is arranged such that when a touch screen is connected to the gateway, it is possible to use the touch screen to enable remote control of the gateway and to download selected test data and test parameters to the gateway and to upload selected test data and test parameters to a remote computer.

Remote control of the gateway refers to the ability to control the gateway remotely. This can be done, for example, by connecting to a remote computer over a network and allowing a user on the remote computer to send commands to the gateway and query its status.

On the one hand, this can help integrate powerful computers and analysis platforms, even when testing is performed remotely from data centers and offices. On the other hand, it increases the protection against attacks by exchanging only necessary data or granting only necessary access rights.

A component or subsystem of a gateway may refer to a part of the gateway that performs a specific function within the overall system. For example, it may be a specific hardware component or a software module.

A device or system connected to the gateway is a device or system that is connected to the gateway via a digital or analog interface and communicates with the gateway.

Test data may refer to data generated or used during a test. For example, it may include measurements, status information, or other relevant data.

Test parameters are parameters that control the execution of a test. For example, they may specify the conditions under which the test is performed or the criteria that may be met for the test to be considered successful.

Test data analysis is the process of examining and interpreting the data generated during a test to gain information about the performance, reliability, or other aspects of the system or device under test.

A remote computer is a computer, such as a server, central processing unit (CPU), electronic control unit (ECU), or the like, located elsewhere, such as in the cloud, that is connected to the gateway via a network. It may be used to control the gateway, receive data from the gateway, or send data to the gateway.

In a further embodiment of the network-to-network gateway according to the present disclosure, the gateway is arranged to be securely updatable and/or flash reprogrammable outside of a secure production environment.

This can help to enable software to be efficiently and securely updated over the course of a lifecycle that can span many years in a vehicle. This can also apply to core areas of the gateway, such as software stored in the gateway's flash memory, which is specially protected against external attacks and tampering. Secure upgradeability and flash reprogrammability can increase the security, reliability and longevity of the gateway.

A secure manufacturing environment is one in which hardware or software is produced under controlled and secure conditions. This environment is designed to ensure the protection of the components produced and the tools and materials used.

Securely updatable as used herein refers to a gateway that is configured to allow software updates to be performed in a secure manner. This includes mechanisms for verifying the integrity and authenticity of updates, for securely transmitting updates and for securely installing updates on the gateway.

Secure flash reprogrammable as used herein refers to a gateway that is configured to allow secure reprogramming of the gateway's flash memory, which stores firmware or other desirable or important software components. This includes mechanisms for verifying the integrity and authenticity of the new software, for securely transferring the new software and for securely installing the new software in the flash memory.

A second aspect of the present disclosure relates to a vehicle, such as an automobile, truck, bus, motorcycle, railroad vehicle, ship or aircraft, having a gateway according to the first aspect of the present disclosure.

A third aspect of the present disclosure relates to a method of developing a network-to-network gateway according to the present disclosure. The method begins by determining additional required features. Features are identified that result from requirements of currently applicable standards and regulations that are not already implemented by the motherboard or data processing unit of the gateway. It also identifies features that result from requirements of the environment in which the gateway is to be used, such as vehicle type, vehicle use, or country, that are also not implemented by the gateway's motherboard or data processing unit. It also identifies features that result from the requirements of a vehicle or vehicle component manufacturer that are not implemented by the gateway's motherboard or data processing unit.

Once these additional required features are identified, they are implemented. For example, the features can be implemented on a first daughter board. In addition, the features implemented on the first daughter board may be implemented redundantly on a second daughter board. The daughter boards are then connected to the motherboard, in particular using detachable connectors.

Features can also be implemented by connecting predefined interfaces and modules to the gateway, such as a predefined digital data interface, serial bus interface, Ethernet interface, debug interface, USB interface, SD card interface, Wi-Fi interface, telematics data interface, Bluetooth interface and/or an array of programmable LEDs, mainly using connectors.

This method enables efficient and flexible development of a network-to-network gateway that can be customized to meet specific requirements. It helps increase deployment efficiency and reduce complexity by eliminating the need for many different, heterogeneous components to provide interfaces and functionality compared to conventional systems. For example, the presence of connectors may help ensure that interfaces are attached only when needed. Otherwise, they can be omitted to reduce the complexity and effort involved in providing the gateway.

In the context of the present disclosure, additional required features refer to features beyond those already implemented in the gateway, in particular in the motherboard or data processing unit. These additional features may result from various requirements, such as current standards and regulations, the specific environment in which the gateway is to be used, or the requirements of a vehicle or vehicle component manufacturer.

Applicable standards and regulations refer to the technical standards and regulations that are current and relevant at the time the gateway is developed. These may vary by region and application, for example.

Application environment refers to the specific context in which the gateway will be used. For example, it may refer to the vehicle type, vehicle usage, or country.

A vehicle or vehicle component manufacturer is a company or organization that manufactures vehicles or vehicle parts. The requirements of this manufacturer may relate to specific features or functions to be incorporated into the gateway.

Another aspect of the present disclosure relates to a method of testing a network-to-network gateway according to the present disclosure. The method includes the following steps:

In one step, a touch screen is detachably connected to the gateway by a connector. Optionally, an analog interface may also be detachably connected to the gateway by a connector.

In another step, the touch screen connected to the gateway is used to select a test, control the execution of a test, enter or display test data or test parameters, select an analysis of test data, control the execution of an analysis of test data and/or enable remote control of the gateway, download data to the gateway, or upload of data to a remote computer.

In this context, the analog interface can help provide direct feedback from analog devices, such as analog sensors or actuators. This can lead to improved diagnostic and test capabilities, as the feedback can be used to verify that control commands have been executed. Further, the feedback may cause or initiate a user to perform some function or task resulting is a desirable change to the analog devices, such as analog sensors or actuators. For example, and without limitation, adjustments or replacement of analog sensors or actuators.

The touch screen directly attached to the gateway can help initiate and control tests and analysis directly at the gateway. This can reduce effort and complexity by eliminating the need to carry additional devices such as a laptop, tablet, or mobile phone and by eliminating the need for additional software such as applications for a laptop, tablet, or mobile phone.

The ability to remotely control, upload and download data using the touch screen on the gateway can help integrate powerful computers and platforms, even when testing is performed remotely from data centers and offices. It can also increase protection against attacks by ensuring that only necessary data is exchanged or access rights are granted.

### BRIEF DESCRIPTION OF THE DRAWINGS

Embodiments of the present disclosure are described in greater detail below in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an embodiment of a network-to-network gateway according to one or more embodiments shown and described herein;

FIG. 2 schematically depicts another embodiment of a network-to-network gateway according to one or more embodiments shown and described herein;

FIG. 3 schematically depicts an embodiment of a vehicle according to one or more embodiments shown and described herein;

FIG. 4 depicts an illustrative flowchart of an embodiment of the method of developing a gateway according to one or more embodiments shown and described herein; and

FIG. 5 depicts an illustrative flowchart of an embodiment of the method for testing one or more embodiments shown and described herein.

### DETAILED DESCRIPTION

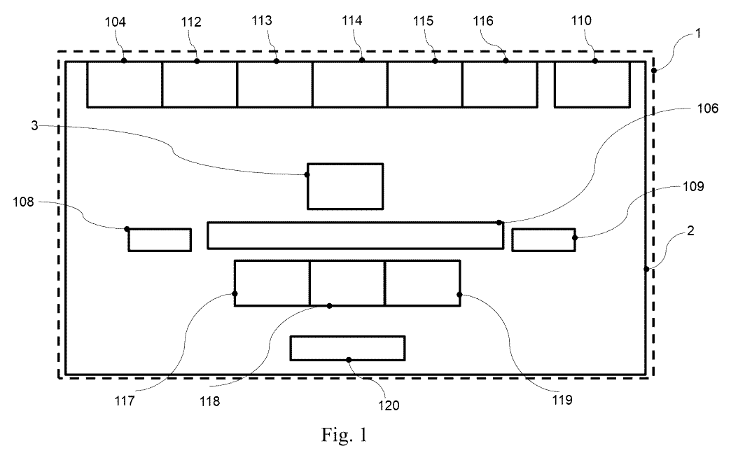

FIG. 1 shows a block diagram of a simplified embodiment of the network-to-network gateway 1 according to the present disclosure. The gateway 1 shown is configured for use in vehicles and includes a main circuit board, or motherboard 2, a data processing unit 3 and a plurality of connectors 104, 106, 108, 109, 110, 112, 113, 114, 115,116, 117, 118, 119, 120, as described in greater detail herein.

The data processing unit 3 may be an electronic control unit (ECU), a central processing unit (CPU), and/or the like, for performing the functions as described herein. For example, the data processing unit 3 may be configured to receive, analyze and process sensor data, perform calculations and mathematical functions, convert data, generate data, and the like. The data processing unit 3 may include one or more processors and other components. For example, one or more memory modules that stores logic that is executable by the one or more processors. Each of the one or more processors may be a controller, an integrated circuit, a microchip, central processing unit or any other computing device. The one or more memory modules may be non-transitory computer readable medium and may be configured a RAM, ROM, flash memories, hard drives and/or any device capable of storing computer-executable instructions, such that the computer-executable instructions can be accessed by the one or more processors. The computer-executable instructions may include logic or algorithms, written in any programming language of any generation such as, for example machine language that may be directly executed by the processors, or assembly language, object orientated programming, scripting languages, microcode, etc., that may be compiled or assembled into computer-executable instructions and storage on the one or more memory modules. Alternatively, the computer-executable instructions may be written in our hardware description language, such as logic implemented via either a field programmable gate array (FPGA) configuration or an application specific integrated circuit (ASIC), all their equivalents. Accordingly, the methods and/or processes described herein may be implemented in any conventional computer programming language, as preprogrammed hardware elements, or as a combination of hardware and software components.

The gateway 1 shown can accommodate a digital data interface 4 by a connector 104 and a touch screen 6 by a connector 106. In addition, the gateway 1 can accommodate a first daughter board 8, which can be detachably connected to the gateway 1 by a connector 108. A second daughter board 9 can also be detachably connected to the gateway via a connector 109. An analog interface 10 can be detachably connected to the gateway via a connector 110.

In addition to the features already mentioned, the gateway 1 can accommodate many other interfaces via a plurality of connectors 112-120, allowing flexible configuration and expansion of the gateway 1. These may include a serial bus interface 12, an Ethernet interface 13, a debug interface 14, a USB interface 15, an SD card interface 16, a Wi-Fi interface 17, a telematics data interface 18, a Bluetooth interface 19 and an array of programmable LEDs 20. Each of these interfaces can be detachably connected to the gateway via the corresponding connector of the plurality of connectors 112-120.

The gateway 1, schematically depicted in FIG. 1, includes connectors without the modules, daughter boards and interfaces that can be connected to them. This illustrates that the gateway 1 can be provided very efficiently and can be easily upgraded according to a desired configuration. The gateway 1 according to the present disclosure need not include all the connectors shown in FIG. 1 and may also include additional connectors that can help provide a customizable and scalable solution to meet different needs.

Connectors as shown in FIG. 1 are configured as stack-on modules (SOMs), which allow easy and quick configuration and expansion of the gateway 1. These embodiments show how the gateway according to the present disclosure can be efficiently provided and set up according to the respective requirements. For example, an analog interface 10 and a touch screen 6 may be installed only during the development and testing phases to allow direct interaction and diagnostics.

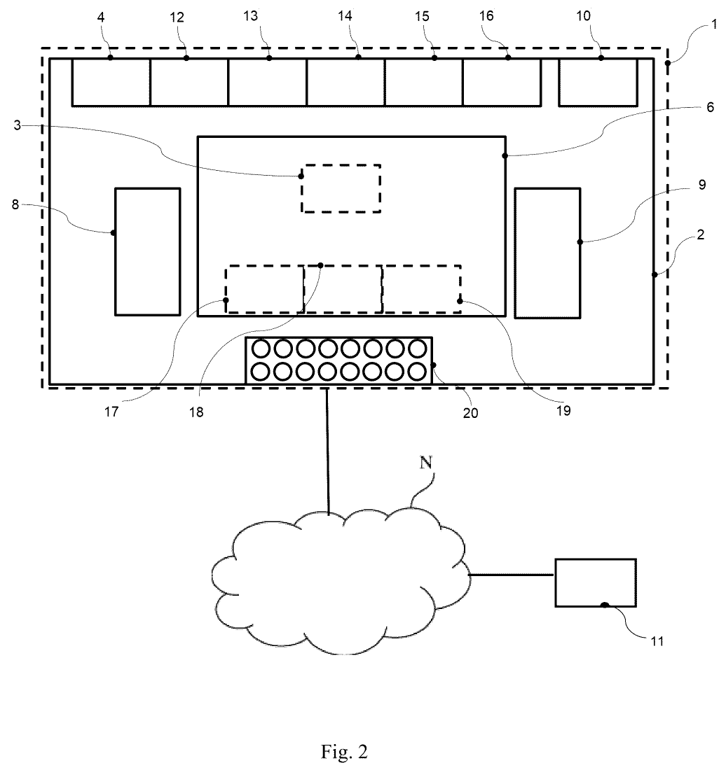

FIG. 2 depicts a block diagram of another simplified embodiment of a network-to-network gateway 1 according to the present disclosure. In this illustration, the gateway 1 is equipped with optional modules, daughter boards and interfaces that allow for flexible and adaptable use in vehicles. The motherboard 2 forms the core of the gateway 1, while the data processing unit 3 provides the necessary computing power.

The digital data interface 4 enables communication with other digital devices and systems and can be connected to the gateway via a connector 104. The touch screen 6 serves as a user interface and can be connected via connector 106. A first daughter board 8 and a second daughter board 9 can help to increase the functionality and functional safety of the gateway. Both can be detachably connected to the gateway via connectors 108 and 109 (FIG. 1).

Additional interfaces such as the analog interface 10, the serial bus interface 12, the Ethernet interface 13, the debug interface 14, the USB interface 15, the SD card interface 16, the Wi-Fi interface 17, the telematics data interface 18, and the Bluetooth interface 19, provide a variety of connection options for different applications. These interfaces can be connected to the gateway via the corresponding connectors 110, 112-119, respectively. An array of programmable LEDs 20, which can be detachably connected via the connector 120, provides additional functionality for user interaction and status indication.

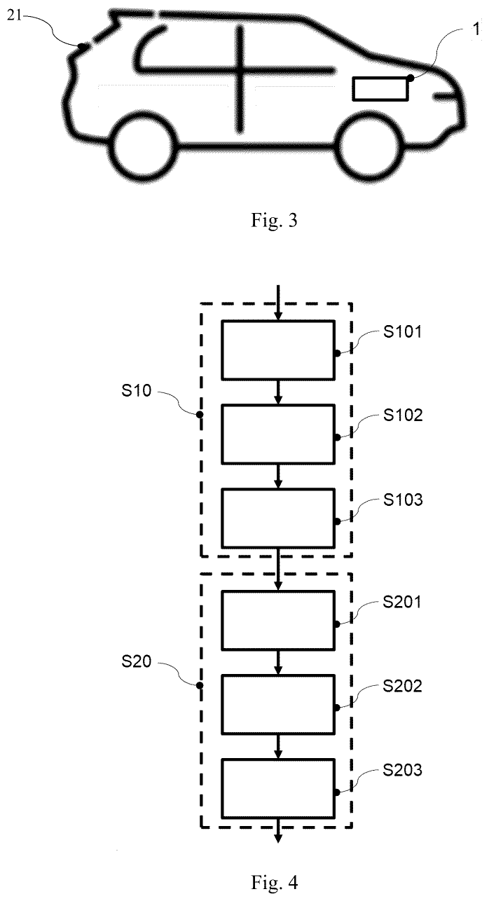

FIG. 3 illustrates a vehicle 21 including the gateway 1 according to a second aspect of the present disclosure. The vehicle 21 may be, for example, a car, a truck, a bus, a motorcycle, a rail vehicle, a ship or an aircraft.

FIG. 4 shows a flowchart of an embodiment of the method for developing a gateway 1 according to a third aspect of the present disclosure.

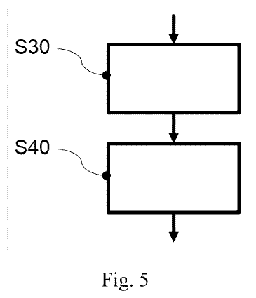

The method shown in FIG. 4 begins with a step S10 in which additionally required features S30 (FIG. 5) are determined which are not already implemented by the gateway 1, in particular not by the motherboard 2 or the data processing unit 3. This includes determining features that result from requirements of currently valid standards and regulations in a sub-step S101, features which result from requirements of the environment in which the gateway is to be used in a sub-step S102, and features which result from requirements of a manufacturer of vehicles or vehicle components in a sub-step S103. The determination of features resulting from requirements features which result from requirements of the manufacturer of vehicles or vehicle components may not be implemented by the motherboard or the data processing unit of the gateway.

In a subsequent step S20, the features determined in the previous step S10 are implemented. This includes, if necessary, the implementation of features on the first daughter board 8 in a sub-step S201, the redundant implementation of features on the second daughter board 9 in a sub-step S202, and the implementation of features by mounting the digital data interface 4, the serial bus interface 12, the Ethernet interface 13, the debug interface 14, the USB interface 15, the SD card interface 16, the Wi-Fi interface 17, the telematics data interface 18, the Bluetooth interface 19 and/or the arrangement of programmable LEDs 20, to the gateway in a sub-step S203, in particular by connectors 104, 106, 108, 110, 112-120, respectively.

The example method allows an efficient and flexible development of a gateway 1 according to the present disclosure, which can be efficiently adapted to different requirements. It helps to increase the efficiency of the implementation and to reduce the complexity. In addition, the presence of connectors can help to ensure that the interfaces are only installed when they are required, otherwise they can be omitted to reduce the complexity and effort in deploying the gateway.

In accordance with a fourth aspect of the present disclosure, FIG. 5 illustrates a flowchart of an embodiment of the method for testing a gateway 1.

The method shown in FIG. 5 begins with the step S30 in which a touch screen 6 is detachably connected to the gateway 1 by a connector 106. Optionally, an analog interface 10 may also be detachably connected to the gateway by a connector 110 at step S30. Once the touch screen 6 is connected, a determination is made as to required features which are not already implemented by the gateway 1, in particular not by the motherboard 2 or the data processing unit 3.

In the next step S40, the connected touch screen 6 is used to perform various functions. For example, and without limitation, selecting a test, controlling the execution of a test, entering and displaying test data and test parameters, selecting an analysis of test data, controlling the execution of an analysis of test data and/or enabling remote control of the gateway 1. In addition, the touch screen 6 may be used to enable downloading of data to the gateway 1 or uploading of data to a remote computer 11, which is communicatively coupled to the gateway 1 via a network N. Such allows for a visual display via the LEDS 20 to inform a user to take action. As such, as discussed herein, this arrangement permits for a notification the user to assist in increasing functional safety or to achieve a safety level according to a predefined standard, such as ASIL C or ASIL D, more efficiently, increasing the reliability and safety of the system, limit possible risks by avoiding systematic errors, detecting random errors and reacting to detected errors, which causes some act or output by the user to return the system to a desirable condition.

As used herein, the term “communicatively coupled” means that coupled components are capable of exchanging data signals and/or electric signals with one another such as, for example, electrical signals via conductive medium, electromagnetic signals via air, optical signals via optical waveguides electrical energy via conductive medium or a non-conductive medium, data signals wirelessly and/or via conductive medium or a non-conductive medium and the like.

The network N may be a computer network and may include a wide area network (WAN), such as the internet, a local area network (LAN), a mobile communications network, a public service telephone network (PSTN) a personal area network (PAN), a metropolitan area network (MAN), a virtual private network (VPN), and/or another network. The network N may generally be configured to electronically connect one or more computing devices and/or components thereof. Illustrative computing devices may include, but are not limited to, the touchscreen 6 and the gateway 1.

The touch screen 6 mounted directly on the gateway makes it easy to start and control tests and analyses directly on the gateway, thereby reducing the effort and complexity of performing tests. Allowing remote control and uploading and downloading of data via the touch screen 6 increases the flexibility and security of the system, as only necessary data is exchanged. When installed, the analog interface 10 provides feedback to analog devices for improved diagnostics and testing.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

The invention claimed is:

1. A network-to-network gateway for use in vehicles, the gateway comprising:
a motherboard;
a data processing unit;
a digital data interface and a first connector for detachably connecting the digital data interface to the gateway, and
a touch screen and a second connector for detachably connecting the touch screen to the gateway.

2. The gateway of claim 1, wherein the gateway further comprises:
a first daughter board; and
a third connector for detachably connecting the first daughter board to the gateway.

3. The gateway of claim 2, wherein the gateway further comprises:
a second daughter board; and
a fourth connector for detachably connecting the second daughter board to the gateway.

4. The gateway of claim 1, wherein the gateway further comprises:
an analog interface; and
a fifth connector for detachably connecting the analog interface to the gateway.

5. The gateway of claim 1, wherein the gateway further comprises:
a serial bus interface and a sixth connector for detachably connecting the serial bus interface to the gateway;
an Ethernet interface configured for data transmission at a rate of 1 gigabit/s or more, and a seventh connector for detachably connecting the Ethernet interface to the gateway;
a debug interface and an eighth connector for detachably connecting the debug interface to the gateway;
a USB interface and a ninth connector for detachably connecting the USB interface to the gateway;
an SD card interface and a tenth connector for detachably connecting the SD card interface to the gateway;
a Wi-Fi interface and an eleventh connector for detachably connecting the Wi-Fi interface to the gateway;
a telematics data interface and a twelfth connector for detachably connecting the telematics data interface to the gateway;
a Bluetooth interface and a thirteenth connector for detachably connecting the Bluetooth interface to the gateway; and
an array of programmable LEDs and a fourteenth connector for detachably connecting the array of programmable LEDs to the gateway.

6. The gateway of claim 5, wherein the serial bus interface is a Local Interconnect Network bus interface or a Controller Area Network bus interface.

7. The gateway of claim 1, wherein the gateway further comprises:
one or more connectors which are designed as stack-on modules.

8. The gateway of claim 1, wherein the gateway is configured, when the touch screen is connected to the gateway, the touchscreen is configured to permit:
selection of a test for testing the function of the gateway, a component or a subsystem of the gateway or a device or system that is connected to the gateway via the analog or digital data interface and to control the execution thereof;
entry and display of test data and test parameters; and
selection of a test data analysis of and control the execution of the test data analysis.

9. The gateway of claim 1, wherein the gateway is configured such that, when the touch screen is connected to the gateway, touch screen enables remote control of the gateway, downloading of selected test data and test parameters to the gateway and uploading of selected test data and test parameters to a remote computer.

10. The gateway of claim 1, wherein the gateway is configured to be securely updatable and/or flash reprogrammable outside a secure production environment.

11. A vehicle comprising the gateway of claim 1.

12. A method for developing a network-to-network gateway, the method comprising the steps of:
determining additionally required features by the following sub-steps:
determining features resulting from requirements of currently valid standards and rule sets which are not implemented by a motherboard or a data processing unit of a gateway;
determining features resulting from requirements of an environment in which the gateway is to be used, the features include at least one of a vehicle type, a vehicle use or a country, which are not implemented by the motherboard or the data processing unit of the gateway; and
determining features resulting from requirements of a manufacturer of vehicles or vehicle components which are not implemented by the motherboard or the data processing unit of the gateway;
implementing features that were determined in the step of determining additionally required features by the following sub-steps:
implementing features on a first daughter board;
redundantly implementing features, which are implemented on the first daughter board, on a second daughter board; and
implementing features by a plurality of detachable connections, between a digital data interface and the first daughter board, the second daughter board, a serial bus interface, an Ethernet interface, a debug interface, a USB interface, a SD card interface, a Wi-Fi interface, a telematics data interface, a Bluetooth interface and an array of programmable LEDs to communicatively couple to the gateway.

13. A method for performing a test by a network-to-network gateway, the method comprising the steps of:
detachably connecting a touch screen to a gateway by a first connector and detachably connecting an analog interface to the gateway by a second connector,
using the touch screen connected to the gateway to:
select a test,
control an execution of a test,
enter test data or test parameters,
display test data or test parameters,
select an analysis of test data,
control an execution of the analysis of test data and/or to enable remote control of the gateway, and
download of data to the gateway or an upload of data to the remote computer.
